(19) United States
(12) Patent Application Publication
(10) Pub. No.: US 2010/0138927 A1
(43) Pub. Date: Jun. 3, 2010

(54) Apparatus and Method for Preventing Unauthorized Access to Secure Information

(76) Inventor: Jonathan D. Callas, San Jose, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/326,751

(22) Filed: Dec. 2, 2008

(51) Int. Cl. G06F 21/00

(52) U.S. Cl. 726/26

(57) ABSTRACT

A computer readable storage medium includes executable instructions to process a duress command to invoke a system termination operation. The duress command may be a pass phrase with an added prefix or suffix. The duress command may be received from a menu, a dedicated key or a key sequence. The system termination operation may result in whole disk encryption. Alternately, the system termination operation may result in permanent destruction of data.

### FIELD OF THE INVENTION

The invention relates generally to the field of data security, and more particularly to an apparatus and method for preventing unauthorized access to secure information.

### BACKGROUND OF THE INVENTION

The protection of business critical confidential data stored on a user's computer is becoming increasingly important as the frequency of computer-related crimes increases. Individuals are increasingly faced with a risk of unauthorized access to critical information, such as social security numbers, credit card numbers and bank statements stored on computer hard drives. There are times when an authorized computer user is coerced into granting access to a computer. A user under such duress may issue an alert sign, which then activates security measures installed in the computer.

Several approaches have been developed to process alert signals. For example, a user may enter a duress code, such as a different username and password to trigger an alarm or slow access to the computer system. Accordingly, a user is likely to avoid physical harm and indirectly alert a system administrator or other official that the user is under some form of duress and that an unauthorized user is attempting to gain access to a computer system. However, a disadvantage of using duress codes is that the user has to remember a duress passphrase when an unauthorized user is attempting to gain access to the user's computer system, which may be difficult when the user is under duress. In addition, if access to the computer system is still granted, confidential information may be disclosed before access is stalled or subsequently denied.

In view of the foregoing, it would be desirable to develop duress security features in computer systems that are more amenable to users under duress and that provide enhanced data security.

### SUMMARY OF THE INVENTION

The invention includes a computer readable storage medium with executable instructions to process a duress command to invoke a system termination operation. The duress command may be a pass phrase with an added prefix or suffix. The duress command may be received from a menu, a dedicated key or a key sequence. The system termination operation may result in whole disk encryption. Alternately, the system termination operation may result in permanent destruction of data.

### BRIEF DESCRIPTION OF THE FIGURES

The invention is more fully appreciated in connection with the following detailed description taken in conjunction with the accompanying drawings, in which:

FIG. 1 illustrates a computer configured in accordance with one embodiment of the present invention.

Like reference numerals refer to corresponding parts throughout the several views of the drawings.

### DETAILED DESCRIPTION OF THE INVENTION

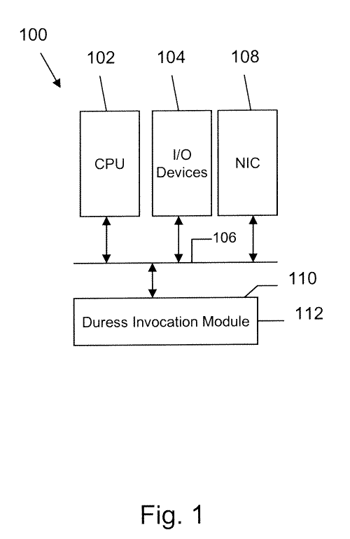

FIG. 1 illustrates a computer configured in accordance with one embodiment of the present invention. The computer 100 includes standard components, including a Central Processing Unit 102 and input output devices 104, which are linked by a bus 106. A network interface circuit (NIC) 108 provides connectivity to a network (not shown), thereby allowing the computer 100 to operate in a networked environment.

A memory 110 is also connected to the bus 106. In one embodiment, the memory 110 includes a Duress Invocation Module 112. The Duress Invocation Module 112 includes executable instructions to receive a duress command. In one embodiment, the Duress Invocation Module 112 includes executable instructions to perform a system termination operation in response to the duress command. The Duress Invocation Module 112 further includes executable instructions to recover from the system termination operation.

The duress command may be in a variety of forms. For example, the duress command may be a standard pass phrase with an additional prefix or suffix. The prefix or suffix may be a single character (e.g., “*”). In this way, the duress command is easy to remember and invoke. Alternately, the duress command may be selected from a menu. Alternately, a dedicated key or key sequence may be utilized. A duress command may be conveyed to a server, which evaluates the circumstances of the command and determines whether to issue a shut down instruction. Alternately, the duress command may be initiated from a server and be delivered to client machines in the event of specified circumstances (e.g., a stolen client machine).

The Duress Invocation Module 112 includes executable instructions to invoke a system termination operation in the form of whole disk encryption. The encrypted disk may then be recovered utilizing a whole disk recovery token. A whole disk recovery token is a generated pass phrase that is a random number (e.g., 128 bits). In one embodiment, it is encoded in Base 32, meaning that a suitable subset of 26 letters and 10 numbers are used. Characters are selected to avoid common mistakes (e.g., between 1 and I or 0 and O). The resultant token looks like a software license number. The token is used like other pass phrases—it is hashed and turned into a key that wraps other keys. After its use, a driver notes that it needs to be replaced, which will be done at the next convenient time.

Alternately, the disk may be recovered by requiring a user pass phrase and a supplementary pass phrase. With this approach, the user must be available, along with an additional individual, such as a system administrator. A hardware recovery token may also be used to recover an encrypted disk.

The Duress Invocation Module 112 may also be implemented to perform a permanent system termination operation. The permanent system termination operation may include an operation to remove all files on a computer. Alternately, the termination operation may include erasing all system disks.

The Duress Invocation Module 112 may also be implemented to perform a remote-reversible system termination operation. This differs from the permanent system termination in that a remote partner of the system owner holds cryptographic credentials that can be used to decrypt the files on the local computer, but the local credentials known to the system's owner are removed. Thus, neither the system's owner nor an attacker who has access to the computer system can decrypt the files on the computer.

In another embodiment, the Duress Invocation Module 112 includes executable instructions to display a termination screen to a user in response to a system termination operation. The termination screen may include system recovery instructions. Alternately, the termination screen may include permanent system termination information advising the user that all data is irretrievably lost.

It should be noted that the executable modules stored in memory 110 are exemplary. Additional modules, such as an operating system or graphical user interface module may also be included. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or server-side. It is the functions of the invention that are significant, not where they are performed or the specific manner in which they are performed.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium comprising executable instructions to:
process a duress command to invoke a system termination operation.

2. The computer readable storage medium of claim 1, comprising executable instructions to recover from the system termination operation by performing a whole disk recovery operation utilizing a whole disk recovery token.

3. The computer readable storage medium of claim 1, comprising executable instructions to recover from the system termination operation by processing a user pass phrase and a supplementary pass phrase.

4. The computer readable storage medium of claim 1, comprising executable instructions to recover from the system termination operation by processing a hardware recovery token.

5. The computer readable storage medium of claim 1, wherein the executable instructions to perform a system termination operation comprise executable instructions to perform a permanent system termination operation.

6. The computer readable storage medium of claim 5, wherein the executable instructions to perform the permanent system termination operation comprise executable instructions to remove all files on the system.

7. The computer readable storage medium of claim 5, wherein the executable instructions to perform the permanent system termination operation comprise executable instructions to erase all system disks.

8. The computer readable storage medium of claim 5, wherein the executable instructions to perform the permanent system termination operation comprise executable instructions to remove all local cryptographic credentials.

9. The computer readable storage medium of claim 1 wherein the duress command is a pass phrase with an added prefix.

10. The computer readable storage medium of claim 1 wherein the duress command is a pass phrase with an added suffix.

11. The computer readable storage medium of claim 1 wherein the duress command is selected from a menu.

12. The computer readable storage medium of claim 1 wherein the duress command is invoked by a dedicated key.

13. The computer readable storage medium of claim 1 wherein the duress command is invoked by a key sequence.

14. The computer readable storage medium of claim 1 wherein the duress command is received from a server.

15. The computer readable storage medium of claim 1, comprising executable instructions to display a termination screen to a user in response to the system termination operation.

16. The computer readable storage medium of claim 15, wherein the termination screen includes system recovery instructions.

17. The computer readable storage medium of claim 15, wherein the termination screen includes permanent system termination information.
